(19) United States
(12) Patent Application Publication
(10) Pub. No.: US 2004/0037687 A1
(43) Pub. Date: Feb. 26, 2004

(54) Transport system for the transport of components

(75) Inventor: Lothar Weiss, Traun (AT)

Correspondence Address: GREENBLUM & BERNSTEIN, P.L.C., 1950 ROLAND CLARKE PLACE, RESTON, VA, 20191, US

(73) Assignee: TMS Produktionssysteme GmbH, Linz (AT)

(21) Appl. No.: 10/610,545

(22) Filed: Jul. 2, 2003

(30) Foreign Application Priority Data
Jul. 3, 2002 (EP) 02014709.6
Nov. 20, 2002 (EP) 02025922.2

(51) Int. Cl. B66C 23/00; B66F 9/00; E02F 3/00

(52) U.S. Cl. 414/680

(57) ABSTRACT

Transport system for transporting components on transport vehicles between stations that includes a movement unit, holding device, and lifting/lowering device for holding device. Lifting/lowering device includes a plurality of constructional elements, which are connected by at least one joint, and at least two constructional elements form a Y-shape. Transport system also includes at least one lifting drive. A point of action of lifting drive is arranged on holding device or in vicinity of an attachment point of holding device to lifting/lowering device, which is located on a constructional element connected to holding device. Point of action is spaced from constructional element with attachment point by a distance between 0 and 50% of length of longest constructional element connected to holding device. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of European Patent Application No. 020 14 709.6 filed Jul. 3, 2002, and of European Patent Application No. 020 25 922.2 filed Nov. 20, 2002, the disclosures of which are expressly incorporated by reference herein in their entireties.

### BACKGROUND OF THE INVENTION

1. Field of the Invention

The present invention relates to a transport system for the transport of components, preferably vehicle bodies, between a plurality of stations, preferably production stations. The plurality of components are transported along a transport path by a plurality of transport vehicles having at least one movement unit, at least one holding device for holding the components and at least one lifting and lowering device for lifting and/or lowering the holding device. The at least one lifting and/or lowering device includes at least one lifting drive and a number of substantially rigid, preferably elongated, constructional elements, which are connected to one another by at least one joint.

2. Discussion of Background Information

Transport vehicles having a lifting and lowering device for lifting and/or lowering the holding device, which carries the components, are known in an extremely wide range of designs.

Such transport vehicles often use what are known as scissors mechanisms as a lifting and lowering device. These exist both moving on the floor and as a suspended table on a transport vehicle, which runs on a rail system and guided on the ceiling. For example, European Patent Application No. EP 1 106 563 A1 discloses such a transport vehicle, the lifting and lowering device being designed as a cable-operated scissors mechanism, which needs complicated cable guides and to some extent considerable cable lengths. Furthermore, the stability with respect to the holding device giving way laterally in an undesired manner is not sufficient in every case. In addition, for constructional reasons, these transport vehicles require a platform with a corresponding size, which makes accessibility to the transported goods more difficult.

Other known transport vehicles are equipped, for example, with telescopic columns, that is to say a plurality of telescopic arms, which are pushed into one another, as lifting and lowering devices, such as disclosed, for example, by Austrian Patent No. AT 399 306 B. In the retracted state of the telescopic columns, a certain minimum overall height is required, depending on the covering over the telescopic arms. If this is not acceptable, a relatively large number of telescopic arms which can be extended is required, which makes the device more expensive.

For reasons of accessibility for corresponding processing, the load is normally located laterally beside the telescopic columns and therefore exerts a bending moment on the column as a result. This solution has the disadvantage that, during loading and unloading, the end of the parts carrier is not only inclined differently, as a result of the bending of the vertical column and as a result of the unavoidable elastic deformation of the components, but also displaced horizontally, which makes exact positioning more difficult.

From the prior part, further lifting and lowering devices are also known. For instance, U.S. Pat. No. 2,766,007 and U.S. Pat. No. 2,785,807 each show a lifting and lowering device with Y-shaped constructional elements. However, the lifting drives of these lifting and lowering devices act on the constructional elements in such a way that a major part of the weight of the load to be lifted has to be absorbed by the lifting and lowering device. The constructional elements of the lifting and lowering device therefore have to be massively dimensioned, which considerably increases the overall weight of the unit. For a transport vehicle of a transport system for which the lowest possible inherent weights are required, the use of such lifting and lowering devices is therefore not desired.

### SUMMARY OF THE INVENTION

Therefore, present invention provides a transport vehicle for a transport system having a lifting and lowering device, which is constructed simply, easily and compactly and can be produced simply and cost-effectively.

According to the invention, at least two constructional elements of the lifting and lowering device are arranged in a Y shape, at least in a lifting position, and the lifting drive acts on the holding device or on a constructional element in the immediate vicinity of the holding device.

What is achieved in this way is a particularly simple and compact construction of the transport vehicle. As a result of the low number of constructional elements needed, such a transport vehicle can also be produced very simply and cost-effectively, and the component to be transported is always freely accessible, since in no lifting position does a constructional element bar access to the component.

Further, the particular point of action of the lifting drive ensures that a major part of the weight of the component is absorbed by the lifting drive and does not need to be absorbed and transmitted by the constructional elements of the lifting and lowering device. Thus, the lifting and lowering device now only has to satisfy a guide function. In this way, the constructional elements can be dimensioned to be very small, as result of which the transport vehicle becomes very light and compact.

At least one constructional element is advantageously arranged such that it can be moved and guided in a guide device, which is arranged on the movement unit, such that the lifting movement can be achieved with very simple constructional elements.

An embodiment of a lifting and lowering device includes a long and a short constructional element. The longer element, which is guided in the guide device, is constructed particularly simply and can be produced very simply.

If the long constructional element is the guided one and is also twice as long as the short one, and if the short one is mounted in an articulated manner in the center of the long one, the result is an exceptionally advantageous embodiment of a transport vehicle, since it is then ensured that the holding device is moved purely vertically, which makes simple positioning of the holding device possible.

In the case of any desired length relationships of the constructional elements, it is particularly advantageous to design the guide device in such a way that, by the kinematics of the lifting and lowering device, that end of the guide element that is connected to the holding device is moved substantially vertically. As a result of this particular configuration of the guide devices, horizontal movement of the holding device can be compensated for, by which simple positioning of the holding device is again made possible.

In one configuration of the lifting and lowering device with two multi-link jointed frames connected to each other and a guide element, the jointed frames preferably are designed as a parallelogram, the result is quite particular advantageous. This is because, on account of the kinematics of such a device, it is ensured that the holding device maintains its original attitude with respect to the horizontal in all lifting positions and is not pivoted by the lifting movement.

With a length ratio of 2:1 between the guide element and a constructional element of the jointed frames and an articulated connection between jointed frames and guide element in the center of the guide element, a purely vertical movement of the holding device is additionally ensured.

A quite particularly simple configuration results if the lifting and lowering device is implemented with at least one multi-link jointed frame including a number of constructional elements connected to one another in an articulated manner, and a guide element. The guide element is preferably connected to the jointed frame in an articulated manner. In this configuration, one jointed frame and one guide element are sufficient to achieve the desired guided lifting movement. For this purpose, only one second guide device is required, which results in a particularly simple and beneficial construction.

The constructional elements, the connecting element and/or the guide element are advantageously implemented as standard components, such as tubes, shaped tubes, or profiled sections, at least to some extent as rods, which simplifies the construction significantly.

The guide device is advantageously a linear guide and arranged on the movement unit, which simplifies the design of the kinematics and the production of the lifting and lowering device.

The achievable lifting height of the lifting and lowering device of the transport vehicle can be increased very simply if the lifting and lowering device is constructed in two parts, one part being built up as a scissors mechanism and the second part being constructed with Y-shaped constructional elements. As a result, the advantage of an extended lifting height with the same overall length in the retracted state is obtained.

If required, the lifting drive can be implemented as a cable drive, chain drive, threaded rod drive, hydraulic cylinder or pneumatic cylinder.

In cases in which particularly heavy components have to be transported, or for reasons of space, at least one lifting and lowering device could in each case be arranged on both sides of the transport vehicle in the transport direction.

A transport vehicle according to the invention may be used particularly advantageously in a transport system for the transport of components, preferably vehicle bodies, between a plurality of stations, preferably production stations, along a transport path, along which a plurality of components can be transported by a plurality of transport vehicles.

A transport system of this type can be designed as a suspended conveyor, preferably an electric suspended conveyor, and the transport vehicle can be designed as a suspended conveyor vehicle.

In such an application, the advantages can be used in their entirety. Good accessibility to the transported goods from above is required, and for this purpose the holding device can be formed in the manner of a hook. Good accessibility for welding or assembly operations also results if, in accordance with the system function, the load is lowered in the assembly areas and therefore, on account of the kinematics, the constructional elements of the lifting and loading device do not get in the way of a manipulator. Only in the lifted position are they located transversely above the load, which does not represent a disadvantage since, in this position, only transport tasks are carried out. In particular in the case of retrofitting the transport device in existing shops, the low overall height which results is of great advantage.

Likewise, precisely in the case of suspended conveyors, a low inherent weight is of great importance. The fact that, in the case of the suspended arrangement, a flexible drive device can be used to provide the lifting force, for example a cable, a belt or a chain on a winch or the like, results here in the possibility of a particularly compact and lightweight embodiment.

A further very beneficial application is a floor-bound transport system having a floor-bound transport vehicle, substantially the same advantages as above resulting.

In order to ensure positionally accurate processing at a station, e.g., a welding station, the holding device or the component can advantageously be transferred or accepted by the lifting and lowering device in a transfer position, and at least one centering device is provided in the transfer position and/or on the holding device or on the component for determining the position of the holding device or the component in the station. As a result, the position of the components in the station can already be determined by the lifting and lowering device, which means that a transport system of this type can be implemented very simply.

For this purpose, the holding device with the component for transfer can be raised or lowered either vertically or, alternatively, as required, also obliquely or in the form of a curve.

The present invention is directed to a transport system for the transport of components on transport vehicles between a plurality of stations along a transport path. The transport system includes at least one movement unit, at least one holding device for, holding the components, and at least one lifting and lowering device for lifting and/or lowering the holding device. The at least one lifting and lowering device includes a plurality of constructional elements, which are connected to one another by at least one joint, and at least two of the plurality of constructional elements are arranged to form, at least in one lifting position, a Y-shape. The transport system also includes at least one lifting drive. A point of action of the lifting drive is arranged on one of the holding device or in a vicinity of an attachment point of the holding device to the lifting and/or lowering device, which is located on a constructional element connected to the holding device. The point of action is spaced from the constructional element including the attachment point by a distance between 0 and 50% of a length of a longest constructional element connected to the holding device.

In accordance with a feature of the invention, the point of action can be spaced from the constructional element including the attachment point by a distance between 0 and 25% of the length of the longest constructional element connected to the holding device.

According to another feature of the invention, the components can include vehicle bodies and the plurality of stations comprises production stations.

According to still another feature of the present invention, a plurality of components can be transported by a plurality of transport vehicles.

The constructional elements may include substantially rigid constructional elements. The rigid constructional elements can include elongated constructional elements.

Further, the plurality of constructional elements may include a first and a second constructional element. One end of the first constructional element can be arranged to be pivotably mounted on the movement unit, and an other end of the first constructional element can be pivotably coupled between two ends of the second constructional element.

The transport device can also include a guide device. At least one constructional element can be pivotably coupled to and arranged for movement in the guide device. The plurality of constructional elements may include at least a first and a second constructional element, and one end of the first constructional element can be formed as a guide element to be pivotably coupled to and arranged for movement in the guide device, and an other end of the guide element can be connected to at least one of the holding device and the second constructional element. One of the first and second constructional elements may be longer than the other. The longer constructional element can be substantially twice as long as the shorter constructional element. Moreover, the shorter constructional element may be attached to substantially a middle of the longer constructional element in an articulated manner. The guide element can be the longer constructional element. As a result of kinematics of the lifting and lowering device, the guide device can move the other end of the guide element, which is connected to the holding device, substantially vertically.

The lifting and lowering device may include at least one multi-link jointed frame, in which the plurality of constructional elements are connected to one another in an articulated manner, and a guide element. At least one of the multi-link jointed frames can be formed as a parallelogram that includes four constructional elements connected to one another in an articulated manner. In this manner, two constructional elements can be arranged substantially parallel in all positions. Each of the multi-link jointed frames may be formed as a parallelogram. At least two of the multi-link jointed frames can be connected by a connecting element that is simultaneously a constructional element of a first jointed frame and a constructional element of a second jointed frame. A constructional unit can be rigidly connected to the movement unit or is formed by the movement unit, such that ends of two further constructional elements are arranged to be pivotably mounted on the constructional unit, while opposite ends of the two further constructional elements are pivotably to the connecting element. In this manner, the connecting element, the constructional unit and the two further constructional elements can be arranged to form the first jointed frame. Another constructional element may be one of rigidly connected to the holding device or formed by the holding device. In this manner, ends of two still further constructional elements can be pivotably mounted on the another constructional element, while opposite ends of the two still further constructional elements are pivotably coupled to the connecting element. The connecting element, the another constructional element, the two still further constructional elements may be arranged to form a second jointed frame. Still further, one end of the guide element can be arranged such that it can be moved and guided in and pivotable relative to a guide device, and an opposite end of the guide element is connected one of to a constructional element of the at least one multi-link jointed frame or to the holding device. The guide element, at least to some extent, forms a constructional element of a multi-link jointed frame. Moreover, the guide element may be longer than a longest constructional element of the at least one multi-link jointed frames. Further, the guide element can be twice as long as a longest constructional element of the at least one multi-link jointed frame. One end of the connecting element can be pivotably mounted on the guide element, and the one end of the connecting element may be pivotably mounted between the two ends of the guide element. Further, the one end of the connecting element is pivotably mounted in the middle of the guide element. At least one of the constructional elements, the connecting element and the guide element can be formed, at least to some extent, as rods, and the rods can be composed of at least one of tubes, shaped tubes and profile sections.

According to still another feature of the present invention, the plurality of construction elements can include at least a first constructional element structured and arranged as a guide device of a second constructional element, which is structured and arranged as a guide element to be moved and guided in the guide device and to be pivotably mounted in the guide device. The lifting and lowering device may include at least one multi-link jointed frame composed of a number of the plurality of constructional elements connected to one another in an articulated manner, and a guide element. The guide element can be formed as part of the jointed frame. Further, the guide element may be connected to the jointed frame in an articulated manner. The transport device can further include a second guide device and a guide element having a predeterminable second point that is guided for movement in, and pivotably coupled to, the second guide device. At least one of the guide element and the jointed frame can be connected to the holding device. The guide device is a first guide device oriented one of substantially horizontally or obliquely to vertical, the transport device may further include a second guide device oriented substantially vertically or obliquely to horizontal.

According to still another feature of the invention, the lifting and lowering device can include at least a first part formed as an X-shaped scissors mechanism, and a second part formed as a Y-shaped unit composed of at least two constructional elements. The first and second parts are arranged to adjoin each other. The transport device may further include a guide device, such that at least one constructional element of the lifting and lowering device is mounted for movement and guidance in the guide device. A constructional element of the X-shaped scissors mechanism can be guided in the guide device. Further, a number of the plurality of constructional elements may be formed as parallelogram-like jointed frames. One of the jointed frames can be connected to the holding device. Also, one of the jointed frames can compose part of the X-shaped scissors mechanism. The first and second guide devices can be arranged on the movement unit. Still further, the first and second guide devices can be formed, at least to some extent, as a linear guide.

Moreover, the transport device may further include devices for moving the transport vehicle coupled to the movement unit. The devices for moving the transport vehicle can include wheels, rollers, drives, and control units.

The lifting drive may include one of a cable drive, chain drive, threaded rod drive; rack drive, hydraulic cylinder and pneumatic cylinder.

At least one lifting and lowering device can be positioned on opposite sides of the transport vehicle in a transport direction.

The transport vehicle may include a vehicle for a suspended conveyor, and the movement unit can be moved by at least one of rollers and wheels on a guide system arranged above a floor. The suspended conveyor can include an electric suspended conveyor.

The transport vehicle can include a floor vehicle, and the movement unit can be one of self-propelled or driven externally on the floor. The floor vehicle may include a thrust platform.

In accordance with still yet another feature of the present invention, one of the holding device or the component can be transferred or accepted by the lifting and lowering device in a transfer position in at least one station. In at least one of in the transfer position and on one of the holding device or component, at least one centering device is located for determining a position of the holding device or the component in the at least one station. The holding device or the component may be lifted or lowered substantially vertically for the transfer or acceptance, and the centering device is correspondingly aligned vertically. Further, the holding device or the component can be lifted or lowered substantially obliquely or in a curved shape for the transfer or acceptance, and the centering device is correspondingly aligned obliquely.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an advantageous embodiment of a transport vehicle according to the invention;

FIGS. 2-5 illustrates further advantageous embodiments of the transport vehicle according to the invention;

FIGS. 6 and 7 each illustrate a configuration of the transport vehicle for an electric suspended conveyor; and

FIG. 8 illustrates a configuration of a transport vehicle as a floor-bound vehicle.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

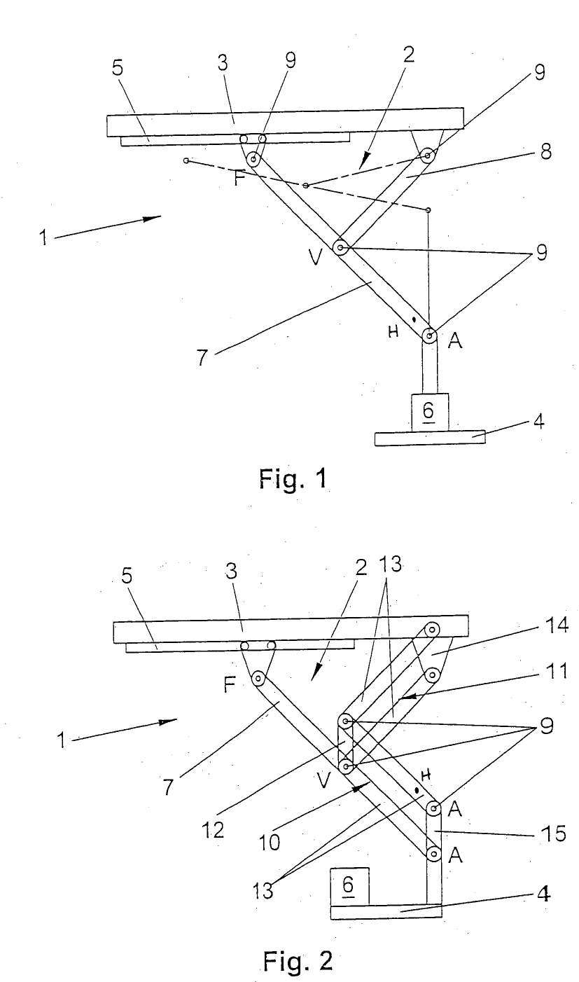

FIG. 1 illustrates a very simple configuration of a transport vehicle 1 according to the invention. In this case, transport vehicle 1 essentially comprises a movement unit 3 which, as a rule, is equipped with sufficiently well known devices, not shown here, for moving transport vehicle 1, such as wheels, rollers, drives, control units, etc., a lifting and lowering device 2 and a holding device 4 fixed to the lifting and lowering device 2 for holding any desired components 6.

In this specific example, lifting and lowering device 2 comprises two constructional elements 7 and 8, e.g., rod shaped elements, which are rotatably (pivotably) connected to each other by joints 9. The longer rod is implemented as a guide element 7 having one end assigned to a guide device 5, to which this one end is mounted for guided movement and pivoting. This pivoting movement is effected by pivotably connecting this one end of guide element 7 to an element of guide 5 via a joint 9, such that this one end of guide element 7 is moved along a predefined path, which in the instant embodiment is a linear path. The, opposite end of guide element 7 is connected to holding device 4 at attachment point A. Short rod 8 of lifting and lowering device 2 is pivotably mounted at one end on movement unit 3 via a joint 9 and is pivotably mounted at its other to guide element 7, i.e., between the two ends of guide element 7, via another joint 9. In a lifted or lowered position, these constructional elements are always arranged in a Y shape.

The lengths of rod 8 and of guide element 7 in the exemplary embodiment according to FIG. 1 are chosen such that guide element 7 is twice as long as short rod 8, and connecting point V, at which guide element 7 and short rod 8 are pivotably connected, is chosen in the middle of guide element 7. Particular kinematic advantages result from this specific configuration. As can easily be thought of in kinematics terms, in the case of this arrangement, in the event of displacement of guide point F along guide device 5, holding device 4 is raised or lowered substantially vertically and there is no horizontal displacement of holding device 4, as indicated by the dashed line in FIG. 1.

Given a rigid connection between guide element 7 and holding device 4, only holding device 4 would be pivoted, by at most 90°. This pivoting could either be accepted as given, or a certain compensation of the attitude of holding device 4 could also be provided. For instance, a pivotable connection could be provided between guide element 7 and holding device 4 at attachment point A, and the pivoting could be compensated for by a suitable device, such as a stepping motor, balance weights or the like, so that a desired attitude, e.g., a horizontal attitude, of holding device 4 is always ensured. In the case of an articulated connection between guide element 7 and holding device 4, as illustrated in FIG. 1, holding device 4 would of course be aligned in such a way that the center of gravity of holding device 4 (including component 6) comes to lie on a vertical line through attachment point A. If component 6 is arranged appropriately on holding device 4, then a horizontal attitude of holding device 4 can be forced very simply.

Of course, the length relationships of constructional elements 7 and 8 and the position of connecting point V can also be chosen differently, such that, under certain circumstances, no pure vertical movement of attachment point A results. This superimposed horizontal movement could, however, be compensated for kinematically, e.g., by a suitable configuration of the guide curve of guide device 5. The design of such a kinematic system, such as a known slotted guide control, belongs to the standard knowledge of an appropriate person skilled in the art and will therefore not be discussed in detail. By contrast, if the end of rod 8 is guided on movement unit 3 in a guide device 5 and, for this purpose, guide element 7 is firmly mounted on movement device 3 such that it can pivot, then the result in the instant embodiment would always be a vertical and horizontal movement of attachment point A, i.e., a movement in the shape of a circular arc, which could not be compensated for either. However, such an arrangement would of course be just as conceivable. However, it would of course also be conceivable to guide both rods 7 and 8 in a guide device 5.

If attachment point A is made to coincide with connecting point V, i.e., the load would act directly on the connection between two rods 7 and 8, then the result will be a V-shaped arrangement of the constructional elements, although this only represents an extreme case of the Y-shaped arrangement and can therefore be subsumed in the term Y-shaped.

Moreover, a drive device (not shown) can be coupled to holding device 4 at lifting point of action H, so that the weight of load 6 is predominantly absorbed by drive. In this manner, lifting and lowering device 2 is given only a guide function, but not the transmission of forces.

FIG. 2 shows a further particular configuration of lifting and lowering device 2 of a transport vehicle 1. In this example, one end of a guide element 7 is mounted such that it can be moved and guided by a guide device 5 and pivoted. However, guide element 7 is connected here to two jointed frames 10 and 11, which are arranged to form a parallelogram having two parallel sides, and guide element 7, to some extent, forms part of one of these jointed frames 10 and 11. In a lifted or lowered position, the constructional elements are always arranged in a Y shape.

Each of the two jointed frames 10 and 11 comprises two longer rods 13 and two shorter rods 12, 14, and 15 (or something rod-like), as constructional elements, which must, of course, in each case have the same length in order to form a parallelogram. A first jointed frame 10 is connected to holding device 4 at the two attachment points A via a rod 15 or rod 15 can be formed by holding device 4 itself. Arranged on rod 15 are two further rods 13 which are mounted via joints 9 such that they can pivot and, on the opposite side, are connected to each other by a connecting element 12, on which two rods 13 are pivotably mounted. In this case, part of guide element 7, in particular the part between connecting point V and the connection to holding device 4, forms one of the two rods 13. The second parallelogram is formed by a constructional element 14, which is formed as part of movement unit 3, onto which two rods 13 are pivotably mounted. The opposite ends of these two rods 13 are connected in an articulated manner by connecting element 12. The two jointed frames 10 and 11, which are connected by connecting element 12, are connected to guide element 7 in an articulated manner via a single connecting point V. As in the embodiment according to FIG. 1, guide element 7 is twice as long as rods 13, and connecting point V is located in the middle of guide element 7. The kinematics of this arrangement result in holding device 4 again being moved only vertically during a movement of guide point F and, because of the two jointed frames 10 and 11, holding device 4 additionally maintains its predefined attitude, i.e., horizontal, in all lifting positions.

If the length ratios of individual constructional elements 7 and 13 of jointed frames 10 and 11 and the position of connecting point V are chosen differently, the result, as already described, would no longer be a purely vertical movement of attachment point A under certain circumstances. This superimposed horizontal movement could be compensated for kinematically, e.g., by suitable configuration of the guide curve of guide device 5. Equally, it would also be conceivable to guide another constructional element or a plurality of constructional elements in a guide device or further guide devices, as already described above.

In both the embodiments described above, the maximum achievable lifting height is predefined by the length of guide element 7, it being possible for the actual lifting range to be predefined or adjusted, for example by the movement play of guide point F, by a lifting drive or by prevailing space conditions.

Of course, it would also be conceivable to provide a further auxiliary guide in addition to guide device 5. For example, attachment point A could be guided in an additional vertical auxiliary guide, or connection point V could be guided in an additional circular auxiliary guide, in order to increase the accuracy. However, such an auxiliary guide would not change the kinematics of lifting and lowering device 2 and would not be absolutely necessary for the function of lifting and lowering device 2, and therefore, in the sense of the invention, would not be understood as a guide device 5 which essentially determines the kinematic relationships of lifting and lowering device 2. In principle, therefore, any desired point on any desired constructional element could be guided in a guide device with which the kinematics and the function would be predefined. Moreover, while providing any further desired additional auxiliary guide would not change the kinematics, it would not be absolutely necessary for the function to provide such a guide, as it would only have a supporting action.

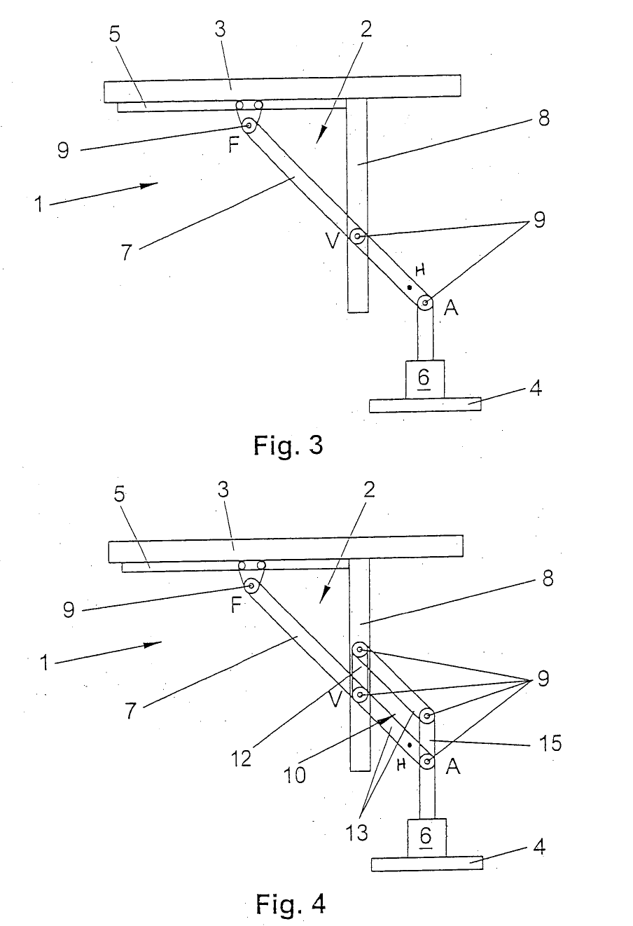

A further very simple configuration of a transport vehicle 1 according to the invention is now illustrated in FIG. 3. In this example, lifting and lowering device 2 comprises two constructional elements 7 and 8, one being implemented here as a rod 7 and the other as a vertical guide device 8. Rod 7 is mounted with one end F such that it can be moved and guided by a horizontal guide device 5 and pivoted and, at a further point V, between the two ends of rod 7, is mounted such that it can be moved and guided in the vertical guide device 8 and pivoted. In this case, both guide devices 5 and 8 are arranged on movement unit 3. The two constructional elements 7 and 8 of lifting and lowering device 2 are arranged unambiguously in a Y shape in the lowest lifting position of holding device 4, i.e., when point V has reached the lower end of guide device 8. However, in every other lifting position, constructional elements 7 and 8 are understood to be arranged in a Y shape, since the unused end of guide device 8 has no function in this lifting position. It can be gathered very simply from the kinematics that attachment point A would move along an elliptical path here during a lifting movement. By appropriate configuration of guide device 5 and/or of guide device 8, it would of course be possible to achieve a substantially vertical movement of holding device 4.

With regard to any possible rotation of holding device 4 during lifting or lowering, that which has already been stated above applies.

If attachment point A and connecting point V were made to coincide at a point, i.e., attachment point A were to be guided directly in vertical guide 8, then a vertical movement of holding device 4 would be achieved very simply. In order to achieve a more compact design, vertical guide device 8 could, for example, also be implemented in the manner of a telescope, i.e., guide device 8 could be extended to a greater or lesser extent depending on the lifting position.

Transport vehicle 1 according to FIG. 3 can also be equipped with a parallel jointed frame 10, as depicted in FIG. 4. However, in contrast to the embodiment of FIG. 2, the embodiment of FIG. 4 only includes one jointed frame 10. Jointed frame 10 comprises four constructional elements 13, 14, and 15, e.g., rods, which are connected to one another via joints 9 to form a parallelogram. One of rods 13 is formed by part of guide element 7. Guide element 7 is mounted at guide point F such that it can be moved and guided in a linear horizontally arranged guide device 5 and pivoted. At connecting point V, jointed frame 10 and guide element 7 are connected to each other in an articulated manner. At the same time, connecting point V and a further point of jointed frame 10 are mounted such that they can be moved and guided in a second linear vertically arranged constructional element, formed as a guide device 8 and belonging to lifting and lowering device 2, and pivoted. As already described in FIG. 2, this jointed frame 10 achieves the situation where holding device 4 can be raised and lowered without pivoting.

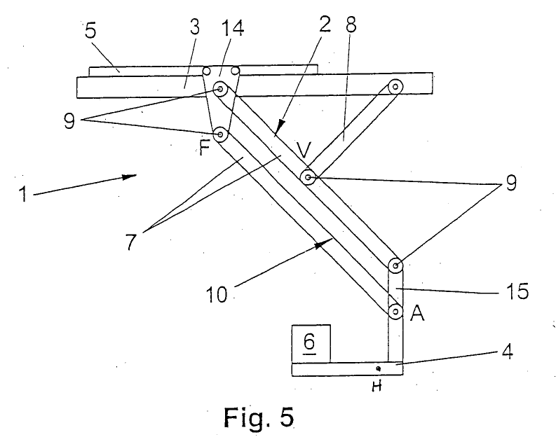

Jointed frame 10 of lifting and lowering device 2 could be guided in a guide device 5, as illustrated in FIG. 5. In this exemplary embodiment, a constructional element 14 can be moved and guided in a guide device 5. Arranged on this constructional element 14, two rods 7 are mounted via joints 9 such that they can be pivoted and, at their opposite ends, are connected via a further rod-like constructional element 15. Constructional elements 7, 14, and 15 thus form a parallelogram-like jointed frame 10. Arranged on constructional element 15 is a holding device 4 having a load 6, it being possible, of course, for constructional element 15 also to be part of holding device 4. A further rod-like constructional element 8 is connected at one end to movement unit 3 and at the other end, at the connecting point V, to a rod 7 of jointed frame 10.

The kinematics of this lifting and lowering device 2 can again be considered very simply. This exemplary embodiment substantially represents a further development of the lifting and lowering device according to FIG. 1 and therefore achieves in particular the situation where the predefined attitude of the holding device 4, here the horizontal, is maintained in every lifting position. Otherwise, what has already been stated in relation to FIG. 1 applies in an analogous manner.

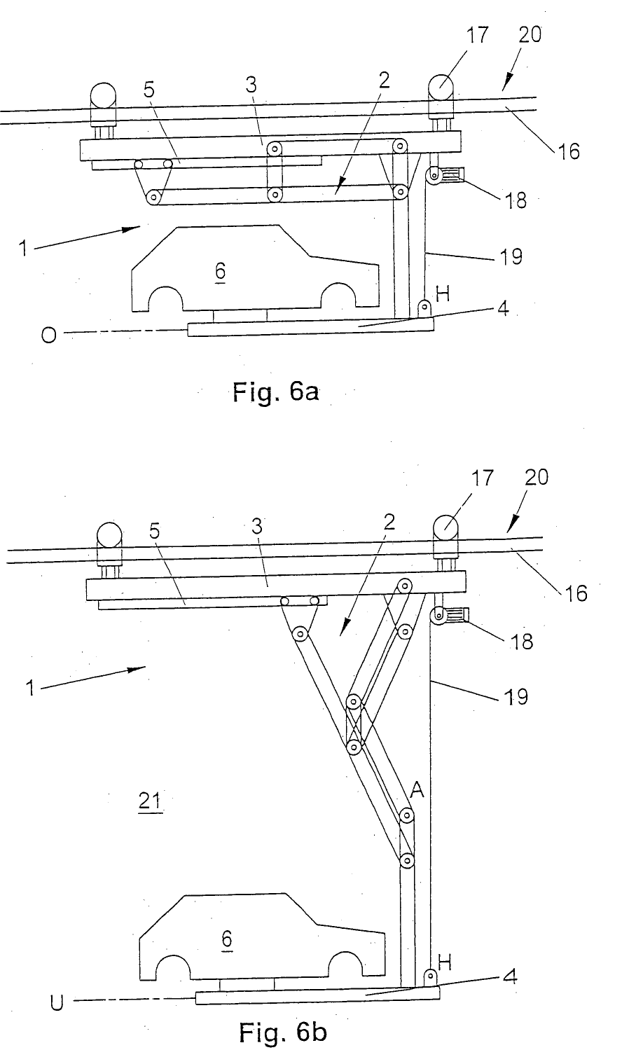

The configuration of a transport vehicle 1 as a vehicle for an electric suspended conveyor is illustrated in FIGS. 6a and 6b. In this case, movement unit 3 has wheels or rollers 17, which are suspended such that they can move on a guide rail 16. Therefore, transport vehicle 1 can be moved along a transport path 20, which is predefined by guide rail 16. For this purpose, a sufficiently well known drive, e.g., towed or self-propelled, is of course required, but this is not illustrated in FIG. 6a or 6b. Transport vehicles 1 are in this case mostly suspended from the ceiling and are transported suspended freely above the floor.

FIG. 6a shows transport vehicle 1 with holding device 4 in an upper end position O, i.e., lifting and lowering device 2 has been retracted completely and holding device 4 has reached its highest position. In this view, it is possible to see the compactness of transport vehicle 1 with lifting and lowering device 2, i.e., transport vehicle 1 needs very little space for the transport of component 6, e.g., a vehicle body.

A lower end position U of holding device 4 is illustrated by way of example in FIG. 6b. In this exemplary embodiment, transport vehicle 1 is located in a workstation 21, such as a welding station, and holding device 4 has been lowered in order to set component 6 down in workstation 21, possibly for machining. Of course, all intermediate positions are also possible.

In order to carry out the lifting movement, a lifting drive 18 is provided on movement unit 3 and is connected to holding device 4 via a cable or a chain. A lifting movement can thus be produced via a cable winch or a chain wheel. Lifting drive 18 acts directly on holding device 4 at lifting point of action H, which means that the weight of load 6 is predominantly absorbed by lifting drive 18, and lifting and lowering device 2 is given only a guide function, but not the transmission of forces.

If lifting drive 18 were not to act on holding device 4 but on a constructional element of lifting and lowering device 2, then the constructional elements of lifting and lowering device 2 would have to absorb and transmit the weight of load 6 and the bending moments produced. For this purpose, the constructional elements would have to be dimensioned appropriately, which would undesirably increase the weight of and the space required by lifting and lowering device 2. This disadvantageous effect becomes more effective the further the lifting point of action H is removed from attachment point A of holding device 4. In the exemplary case, lifting drive 18 should therefore act in the vicinity of holding device 4, so that the loading on lifting and lowering device 2 becomes as low as possible and lifting and lowering device 2 can be dimensioned as lightly and compactly as possible. In particular, lifting point of action H of lifting drive 18 should be removed by no more than 50% of the overall length of the constructional element connected to holding device 4, and preferably 15% or 25%, from attachment point A of holding device 4.

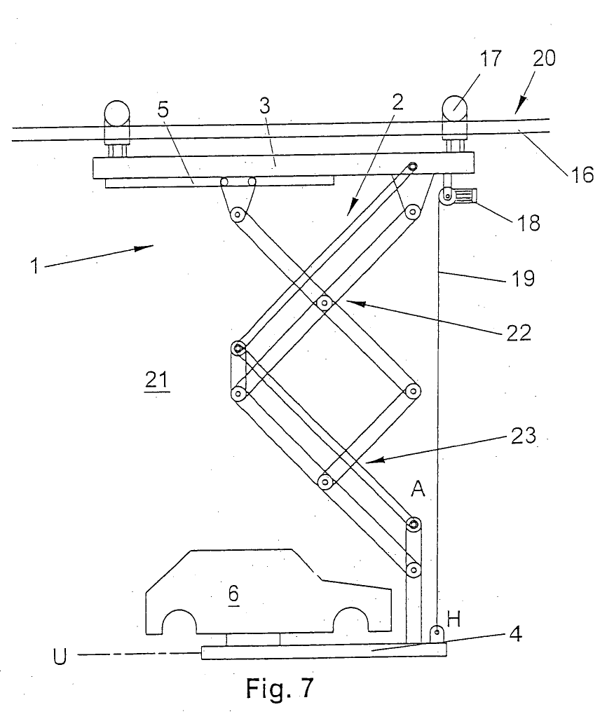

In order to increase the possible lifting height of lifting and lowering device 2 of a transport vehicle 1, FIG. 7 shows a design variant in which lifting and lowering device 2 has been expanded with a conventionally known scissors mechanism 22. In this case, a Y-shaped part 23 of lifting and lowering device 2 is associated with load 6, which means that the advantages of the Y-shaped arrangement are maintained, and scissors mechanism 22 associated with movement unit 3 is provided. The kinematics of lifting and lowering device 2 can be influenced very simply by the configuration and connection of constructional elements and of the guide device 5, as explained exhaustively above.

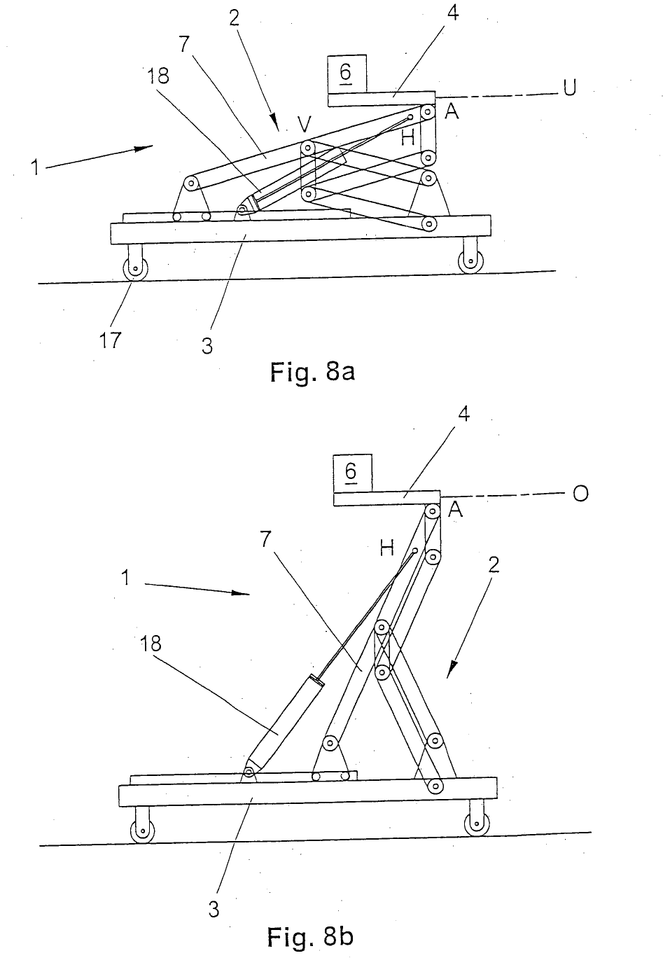

A floor-guided transport vehicle 1 is illustrated in FIG. 8. In the case of this vehicle, movement unit 3 has wheels or rollers 17 or the like, by which transport vehicle 1 can be moved on the floor. For this purpose, sufficiently well known guide or steering systems could be provided on the floor in order to move transport vehicle 1 along a track. Component 6 can be moved from a lower end position U, FIG. 8a, into an upper end position O, FIG. 8b. Of course, all intermediate positions are also possible. For this purpose, lifting drive 18 provided here on movement unit 3 is a pneumatic or hydraulic cylinder, whose movable piston acts on lifting action point H on a constructional element of lifting and lowering device 2. Lifting action point H is in this case arranged in the vicinity of attachment point A of holding device 4, i.e., in a region of 0 to 50% of the length of constructional element 7 on which lifting action point H is arranged.

A transport vehicle 1 according to the invention could of course be equipped with more than one lifting and lowering device 2. It would be conceivable to provide, e.g., one or more lifting or lowering devices 2 in each case on both sides in the direction of travel of transport vehicle 1.

It would also be conceivable to configure lifting and lowering device 2 differently within the scope of the invention. For example, two rods 8 located beside each other, as viewed in the direction of travel, or two jointed frames 10 and 11 could be provided, between which guide element 7 is arranged. A configuration of this kind would have the advantage that, on account of the symmetrical arrangement of the constructional element, this would be substantially moment-free. However, all other possible kinematic configurations are of course covered by this invention.

If, in the above embodiments, mention is made of the length of a rod or constructional element, then this is of course to be understood to mean the straight-line distance between the points of rotation of two joints. The extent to which the constructional elements project beyond the point of rotation is of no importance.

The same also applies to the end of the constructional element. “End” is not necessarily to be understood to mean the actual end of the constructional element; instead this again refers to a point of rotation. The constructional element can in this case of course project beyond the point of rotation.

Of course, without restriction, any desired constructional elements, such as rods, beams, tubes, shaped tubes, etc. can be used, which of course would also be shaped as desired, such as straight, curved, etc.

A transport vehicle 1 as described above can be used, e.g., in production lines in the automotive industry for the transport of bodies or body parts, such as a suspended conveyor. In this case, a plurality of transport vehicles 1 is moved between a plurality of workstations 21, e.g., welding stations. Transport vehicles 1 are moved along a rail fixed into the ceiling, for which purpose movement unit 3 of transport vehicle 1 must be designed accordingly. In workstations 21, holding devices 4 with components 6 are lowered for machining. As a result of the specific kinematics of lifting and lowering device 2, components 6 are freely laterally accessible on holding device 4 and can therefore be machined unimpededly, for example by welding robots.

For accurate positional fixing during the transfer or acceptance of holding devices 4 or components 6 from/to machining stations and other transport devices, centering devices, such as guide pins or holding pins, are normally used. As a result of the guided movement, preferably a purely vertical movement, holding devices 4 and components 6 can slide simply and reliably into the centering devices. In the case of the present transport vehicle according to the invention, there is no lateral giving way when the load moment changes, caused by the off-center load on the parts carrier. Only slight tilting occurs, depending on the expansion or shortening of the constructional elements of the lifting and lowering device of the jointed frames as the load moment changes. As a result, no forcing into guide pins or other centering means can occur, which permits reliable positioning.

In order to transfer holding device 4 or component 6 in a workstation 21, it does not necessarily have to be lowered or lifted vertically. Of course, centering devices arranged obliquely could also be provided, which would then permit a corresponding transfer of holding device 4 with an oblique or curved movement of holding device 4.

In addition, the folding mechanism of lifting and lowering device 2 has the advantage that lines for the supply, for example of power, water, compressed air, etc., to devices on the holding device, such as clamping or welding devices, can be led along the constructional elements in a simple manner, these not having to be protected specifically, since the constructional elements are not in the working region, because of the kinematics, and the risk of damage to the lines is therefore low.

Of course, the guide devices used can be any desired, sufficiently constructions that are well known, therefore not described specifically here, such as a pin, a carriage or a roller, which are guided in a corresponding rail, or else a sliding-rod guide, slotted guide, etc.

It is noted that the foregoing examples have been provided merely for the purpose of explanation and are in no way to be construed as limiting of the present invention. While the present invention has been described with reference to an exemplary embodiments it is understood that the words which have been used herein are words of description and illustration, rather than words of illustration. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A transport system for the transport of components on transport vehicles between a plurality of stations along a transport path, comprising:
at least one movement unit;
at least one holding device for holding the components;
at least one lifting and lowering device for lifting and/or lowering the holding device, the at least one lifting and lowering device comprising a plurality of constructional elements, which are connected to one another by at least one joint, and at least two of the plurality of constructional elements are arranged to form, at least in one lifting position, a Y-shape;
at least one lifting drive;
a point of action of the lifting drive is arranged on one of the holding device or in a vicinity of an attachment point of the holding device to the lifting and/or lowering device, which is located on a constructional element connected to the holding device,
wherein the point of action is spaced from the constructional element including the attachment point by a distance between 0 and 50% of a length of a longest constructional element connected to the holding device.

2. The transport device in accordance with claim 1, wherein the point of action is spaced from the constructional element including the attachment point by a distance between 0 and 25% of the length of the longest constructional element connected to the holding device.

3. The transport device in accordance with claim 1, wherein the components comprise vehicle bodies and the plurality of stations comprises production stations.

4. The transport device in accordance with claim 1, wherein a plurality of components is transported by a plurality of transport vehicles.

5. The transport device in accordance with claim 1, wherein the constructional elements comprise substantially rigid constructional elements.

6. The transport device in accordance with claim 5, wherein the rigid constructional elements comprise elongated constructional elements.

7. The transport device in accordance with claim 1, the plurality of constructional elements comprise a first and a second constructional element, wherein one end of the first constructional element is arranged to be pivotably mounted on the movement unit, and an other end of the first constructional element is pivotably coupled between two ends of the second constructional element.

8. The transport device in accordance with claim 1, further comprising a guide device, wherein at least one constructional element is pivotably coupled to and arranged for movement in the guide device.

9. The transport device in accordance with claim 8, wherein the plurality of constructional elements comprise at least a first and a second constructional element, and one end of the first constructional element is formed as a guide element to be pivotably coupled to and arranged for movement in the guide device and an other end of the guide element is connected to at least one of the holding device and the second constructional element.

10. The transport device in accordance with claim 9, wherein one of the first and second constructional elements is longer than the other.

11. The transport device in accordance with claim 10, wherein the longer constructional element is substantially twice as long as the shorter constructional element.

12. The transport device in accordance with claim 11, wherein the shorter constructional element is attached to substantially a middle of the longer constructional element in an articulated manner.

13. The transport device in accordance with claim 12, wherein the guide element is the longer constructional element.

14. The transport device in accordance with claim 9, wherein, as a result of kinematics of the lifting and lowering device, the guide device moves the other end of the guide element, which is connected to the holding device, substantially vertically.

15. The transport device in accordance with claim 1, wherein the lifting and lowering device comprises at least one multi-link jointed frame, in which the plurality of constructional elements are connected to one another in an articulated manner, and a guide element.

16. The transport device in accordance with claim 15, wherein at least one the multi-link jointed frames is formed as a parallelogram that comprises four constructional elements connected to one another in an articulated manner, whereby two constructional elements are arranged substantially parallel in all positions.

17. The transport device in accordance with claim 15, wherein each of the multi-link jointed frames is formed as a parallelogram.

18. The transport device in accordance with claim 15, wherein at least two of the multi-link jointed frames are connected by a connecting element that is simultaneously a constructional element of a first jointed frame and a constructional element of a second jointed frame.

19. The transport device in accordance with claim 18, wherein a constructional unit is rigidly connected to the movement unit or is formed by the movement unit, such that ends of two further constructional elements are arranged to be pivotably mounted on the constructional unit, while opposite ends of the two further constructional elements are pivotably to the connecting element, whereby * the connecting element, the constructional unit and the two further constructional elements are arranged to form the first jointed frame.

20. The transport device in accordance with claim 19, wherein another constructional element is one of rigidly connected to the holding device or formed by the holding device, such that ends of two still further constructional elements are pivotably mounted on the another constructional element, while opposite ends of the two still further constructional elements are pivotably coupled to the connecting element, whereby the connecting element, the another constructional element, the two still further constructional elements are arranged to form a second jointed frame.

21. The transport device in accordance with claim 15, wherein one end of the guide element is arranged such that it can be moved and guided in and pivotable relative to a guide device, and an opposite end of the guide element is connected one of to a constructional element of the at least one multi-link jointed frame or to the holding device.

22. The transport device in accordance with claim 21, wherein the guide element, at least to some extent, forms a constructional element of a multi-link jointed frame.

23. The transport device in accordance with claim 21, wherein the guide element is longer than a longest constructional element of the at least one multi-link jointed frames.

24. The transport device in accordance with claim 23, wherein the guide element is twice as long as a longest constructional element of the at least one multi-link jointed frame.

25. The transport device in accordance with claim 23, wherein one end of the connecting element is pivotably mounted on said guide element.

26. The transport device in accordance with claim 23, wherein said one end of the connecting element is pivotably mounted between the two ends of said guide element.

27. The transport device in accordance with claim 26, wherein the one end of the connecting element is pivotably mounted in the middle of the guide element.

28. The transport device in accordance with claim 23, wherein at least one of the constructional elements, the connecting element and the guide element is formed, at least to some extent, as rods.

29. The transport device in accordance with claim 28, wherein the rods are composed of at least one of tubes, shaped tubes and profile sections.

30. The transport device in accordance with claim 1, the plurality of construction elements comprise at least a first constructional element structured and arranged as a guide device of a second constructional element, which is structured and arranged as a guide element to be moved and guided in the guide device and to be pivotably mounted in the guide device.

31. The transport device in accordance with claim 30, wherein the lifting and lowering device comprises at least one multi-link jointed frame composed of a number of the plurality of constructional elements connected to one another in an articulated manner, and a guide element.

32. The transport device in accordance with claim 31, wherein the guide element is formed as part of the jointed frame.

33. The transport device in accordance with claim 31, wherein the guide element is connected to the jointed frame in an articulated manner.

34. The transport device in accordance with claim 31, further comprising a second guide device and a guide element having a predeterminable second point being guided for movement in, and pivotably coupled to, the second guide device.

35. The transport device in accordance with claim 31, wherein at least one of the guide element and the jointed frame is connected to the holding device.

36. The transport device in accordance with claim 31, wherein the guide device is a first guide device oriented one of substantially horizontally or obliquely to vertical, the transport device further comprises a second guide device oriented substantially vertically or obliquely to horizontal.

37. The transport device in accordance with claim 1, wherein the lifting and lowering device comprises at least a first part formed as an X-shaped scissors mechanism, and a second part formed as a Y-shaped unit composed of at least two constructional elements, and
wherein the first and second parts adjoin each other.

38. The transport device in accordance with claim 37, further comprising a guide device,
wherein at least one constructional element of the lifting and lowering device is mounted for movement and guidance in the guide device.

39. The transport device in accordance with claim 38, wherein a constructional element of the X-shaped scissors mechanism is guided in the guide device.

40. The transport device in accordance with claim 37, wherein a number of the plurality of constructional elements is formed as parallelogram-like jointed frames.

41. The transport device in accordance with claim 40, wherein one of the jointed frames is connected to the holding device.

42. The transport device in accordance with claim 41, wherein one of the jointed frames composes part of the X-shaped scissors mechanism.

43. The transport device in accordance with claim 34, wherein the first and second guide devices are arranged on the movement unit.

44. The transport device in accordance with claim 34, wherein the first and second guide devices are formed, at least to some extent, as a linear guide.

45. The transport device in accordance with claim 1, further comprising devices for moving the transport vehicle coupled to the movement unit.

46. The transport device in accordance with claim 45, wherein the devices for moving the transport vehicle comprise wheels, rollers, drives, and control units.

47. The transport device in accordance with claim 1, wherein the lifting drive comprises one of a cable drive, chain drive, threaded rod drive, rack drive, hydraulic cylinder and pneumatic cylinder.

48. The transport device in accordance with claim 1, wherein at least one lifting and lowering device positioned on opposite sides of the transport vehicle in a transport direction.

49. The transport device in accordance with claim 1, wherein the transport vehicle comprises a vehicle for a suspended conveyor, and the movement unit is moved by at least one of rollers and wheels on a guide system arranged above a floor.

50. The transport device in accordance with claim 49, wherein the suspended conveyor comprises an electric suspended conveyor.

51. The transport device in accordance with claim 1, wherein the transport vehicle comprises a floor vehicle, and the movement unit is one of self-propelled or driven externally on the floor.

52. The transport device in accordance with claim 51, wherein the floor vehicle comprises a thrust platform.

53. The transport device in accordance with claim 1, wherein one of the holding device or the component are transferred or accepted by the lifting and lowering device in a transfer position in at least one station,
wherein, at least one of in the transfer position and on one of the holding device or component, at least one centering device is located for determining a position of the holding device or the component in the at least one station.

54. The transport device in accordance with claim 53, wherein the holding device or the component is lifted or lowered substantially vertically for the transfer or acceptance, and the centering device is correspondingly aligned vertically.

55. The transport device in accordance with claim 53, wherein the holding device or the component is lifted or lowered substantially obliquely or in a curved shape for the transfer or acceptance, and the centering device is correspondingly aligned obliquely.
